(19) United States
(12) Patent Application Publication
(10) Pub. No.: US 2010/0213396 A1
(43) Pub. Date: Aug. 26, 2010

(54) Throttle Valve Used for Recharging Aquifers

(76) Inventors: Mark H. Peterson, Las Vegas, NV (US); Robert L. Tribble, Las Vegas, NV (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/390,875

(22) Filed: Feb. 23, 2009

(51) Int. Cl. F16K 31/12; F16K 15/18

(52) U.S. Cl. 251/12; 137/511

(57) ABSTRACT

In order to prevent cascading of water flowing through a recharge pipe used for recharging an underground aquifer and to thereby minimize or eliminate introduction of air into aquifers, a valve is provided at the lower end of the recharge pipe which controls the rate of flow of recharge water. This is accomplished by providing an array of elongated, vertically extending slots in a section of the recharge pipe proximate the lower end of the recharge pipe, which slots are progressively opened by an overlying valve sleeve. In order to prevent recharge water from spraying laterally from the recharge pipe when the recharge valve is open, a throttle skirt extends laterally from the valve sleeve in spaced relation to the pipe so as to deflect the recharge water downwardly and directly toward the aquifer. This prevents the recharge well from being blocked by debris from the wall of the recharge well.

### FIELD OF THE INVENTION

This invention is generally directed to a throttle valve used to regulate water flow when recharging aquifers.

### BACKGROUND OF THE INVENTION

Many water districts and communities have realized the need and value of maintaining the water level and storage capacity of aquifers that provide drinking and irrigation water. Furthermore, due to high demand and to variability of supply and demand, it is desirable that an adequate reserve capacity of water storage facilities be maintained to provide for extended peak demands, droughts and explosive growth of new customers. Reserve storage capacity to provide for such events in capital facilities is prohibitively expensive to construct and difficult to justify. Accordingly, capital facilities typically lag behind demand.

In an effort to reduce these capital facility costs, water resource engineers have become interested in the concept of replacing or storing large volumes of treated water in aquifers during periods when both water and facility capacity are available to provide water required to recharge aquifers. The concept replacing the water pumped from the aquifer or seasonal storage is called Aquifer Storage Recovery or ASR. This scenario is a cost effective alternative to conventional approaches to the expansion of water supply, treatment, distribution and water storage capital facilities. In general, a well based system or one that is partially well based is a system in which wells can be used for both recharge and recovery. In recovery, the water may require only disinfection. Recharge wells may be through existing wells or through dedicated recharge wells.

In addition to reduction in facilities expansion costs, other advantages favor recharge technology. In coastal areas reduced levels in aquifer water may permit the intrusion of salt water which can result in the destruction of the fresh water supply. In these areas, a mound of recharged fresh water is placed, through balanced flow control, in the aquifer forming a uniform curtain or barrier between salt water and fresh water, effectively preventing salt water intrusion. At times, this volume of water can be used to meet seasonal peak demands.

Such storage and water resource techniques have proven extremely advantageous and cost effective in areas where declining ground water levels have reduced or left wells nearly non-productive.

Another application of this type of device is the use in ground water remediation. In areas where existing ground water supplies are threatened or have been contaminated, flow control devices are effective in managing an effective program. Once the water is extracted and treated, this type of flow control device is able to balance the flow in a series of recharge wells to provide a uniform curtain of water, placing the water in the aquifer evenly and uniformly.

Well recharging is also effective where substantial reserves are necessary to improve system reliability in the event of a catastrophic loss of a primary water supply or in communities where strategically located reserves are required to ensure an adequate balance in system flows during peak demand.

Although there are obvious benefits to be obtained from recharging existing production water wells or in constructing new water storage recovery wells, in many applications problems have been encountered with air entrapment in the recharge water causing air binding of the aquifer. Air binding effectively decreases the permeability of the aquifer, thereby decreasing the effectiveness of the recharging operations. Such air entrapment is most frequently encountered in areas or localities where one or more of three conditions exist. These conditions may be encountered when: (1) the recharge water must drop a considerable distance from the well head to the static water level; (2) when the recharge flow is relatively low; and (3) where the specific capacity of the well is relatively high. The foregoing conditions have resulted in the cascading of water in the recharge column or drop pipe, thereby entrapping large quantities of air which is carried into the well and outwardly into the aquifer. The entrapped air can effectively plug or seal the aquifer, a condition known as air fouling, resulting in substantially lower permeability and storage capacity.

The foregoing problem has been addressed in U.S. Pat. Nos. 5,503,363; 5,618,022; 5,871,200 and 6,073,906; however there is some concern that lateral ejection of water from the outlet ports will damage the recharge well by creating debris that will clog wells and damage downhole pumps used to recycle recharge water.

### SUMMARY OF THE INVENTION

In view of the aforementioned concerns a recharge pipe for mounting in a recharge well has a pipe section with a valve mounted in an intermediate pipe portion. The valve has an upper end for connecting through the recharge pipe to a source of pressurized water and a lower end for coupling with a flow inhibitor. A plurality of outlet ports are provided in the intermediate portion, through which outlet ports pressurized water flows into the aquifer.

A sleeve is positioned over at least the intermediate pipe section, the sleeve being movable between a first position in which the sleeve covers the outlet ports to block the flow of water out of the outlet ports and a second position in which the sleeve at least partially uncovers the outlet ports to throttle water flowing therefrom into the aquifer. A throttle skirt extends axially from the sleeve. The throttle skirt has a length sufficient to overlie the outlet ports and is in radial spaced relation to the intermediate portion of the pipe section. A downwardly facing opening is defined by the throttle skirt to direct water passing through the openings in the intermediate portion into the well in the axial direction of the pipe section to fill the aquifer. An actuator in operative relation with the sleeve, axially translates the sleeve so as to minimize cascading of refill water flowing down the recharge pipe.

In another aspect of the downhole flow control, the actuator is hydraulic.

In still another aspect of the downhole flow control, the outlet ports are spaced elongated slots extending axially with respect to the pipe section.

In still another aspect of the downhole flow control, the outlet ports are four to twelve in number.

In another aspect of the downhole flow control, the outlet ports are located axially below the actuator so that the sliding sleeve progressively closes the outlets upon being lowered to cover the outlet ports.

In still another aspect of the downhole flow control, the actuator is hydraulic and comprises a double acting hydraulic actuator associated with the sleeve for moving the sleeve between the first and second positions to keep the recharge pipe filled with water, whereby air does not become entrained in the water as the water moves through the recharge pipe to enter the aquifer.

In a further aspect of the downhole flow control, the valve is connected at the upper end thereof directly to the recharge pipe and is connected at the lower end thereof to a vertical downhole pump, the vertical downhole pump having a foot valve at the other end thereof, the flow inhibitor being a check valve.

In a further aspect of the downhole flow control, the valve is configured as a pipe section and is connected at the upper end thereof to the recharge pipe, the flow inhibitor being a blind flange.

### BRIEF DESCRIPTION OF THE DRAWINGS

Various other features and attendant advantages of the present invention will be more fully appreciated as the same becomes better understood when considered in conjunction with the accompanying drawings, in which the reference characters designate the same or similar parts throughout the several views, and wherein:

FIG. 1 is a side elevation of a recharge well with a recharge pipe therein having a valve with a flow control configured in accordance with the present invention;

FIG. 2 is a side perspective view of the valve shown in FIG. 1 with the valve in a closed position;

FIG. 3 is a view similar to FIG. 2 showing the valve in a partially open position;

FIG. 4 is a view similar to FIGS. 2 and 3 showing the valve in a fully open position;

FIG. 5 is a perspective view showing the valve closed, and

FIG. 6 is a perspective view showing the valve open.

### DETAILED DESCRIPTION OF THE DRAWINGS

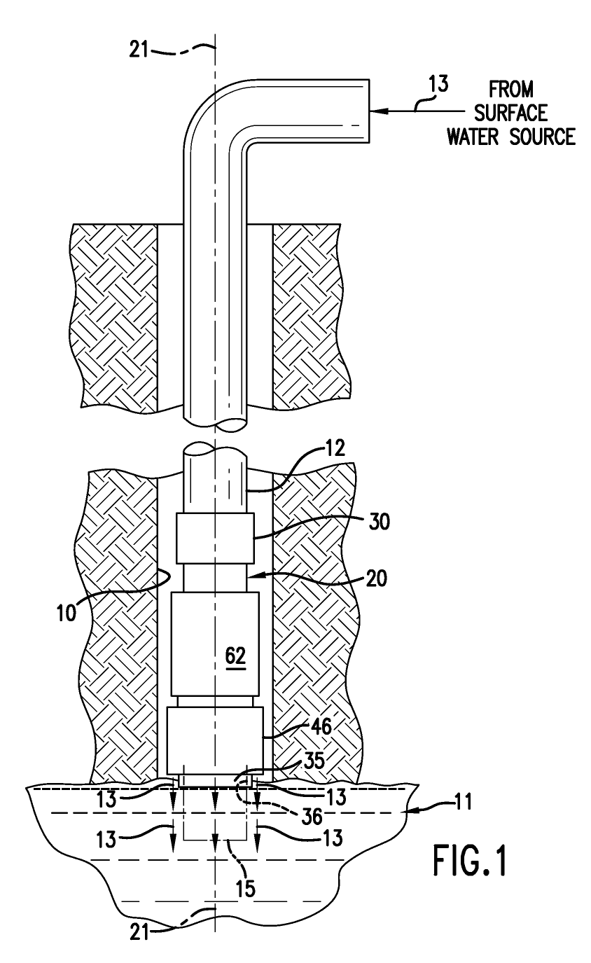

Referring now to FIG. 1 there is shown a recharge well 10 for recharging aquifers 11 by delivering water 13 from a surface source to the aquifers through a recharge pipe 12. The recharge pipe 12 has an outlet end 14 to which is attached an end device 15. Depending on the purpose of the recharge well 10, the end device 15 may be in the form of a return pump, a check valve or a blind flange. If the recharge well 10 is configured for returning water to the surface location for substantially current use then the end device 15 is in the form of a pump. An example of current use is a system where purified sewage water is pumped back into an underground storage facility and then repumped to the surface to irrigate a golf course. An example where the device 15 is a dedicated device for refilling an aquifer, is where surface water is pumped into an aquifer from a reservoir or other source of ground water for use in dry seasons or periods in drought.

As will be explained hereinafter, a difficulty with currently available arrangements for recharging aquifers 11 is that the walls 18 of the recharge wells 10 can be eroded by lateral discharge of pressurized water 13 that displaces portions of the walls into the aquifer, thus potentially clogging the recharge system. This can occur by debris from the walls 18 of the well 10 clogging the aquifer 11 itself, or from the walls of the well generating debris that clogs a return pump at location 15. Applicant has now configured the recharged pipe 12 to address this concern by having a downhole flow control 20 that directs recharge water 13 downwardly in the direction of the pipe axis 21, rather than laterally against the side wall 18 of the recharge well 10.

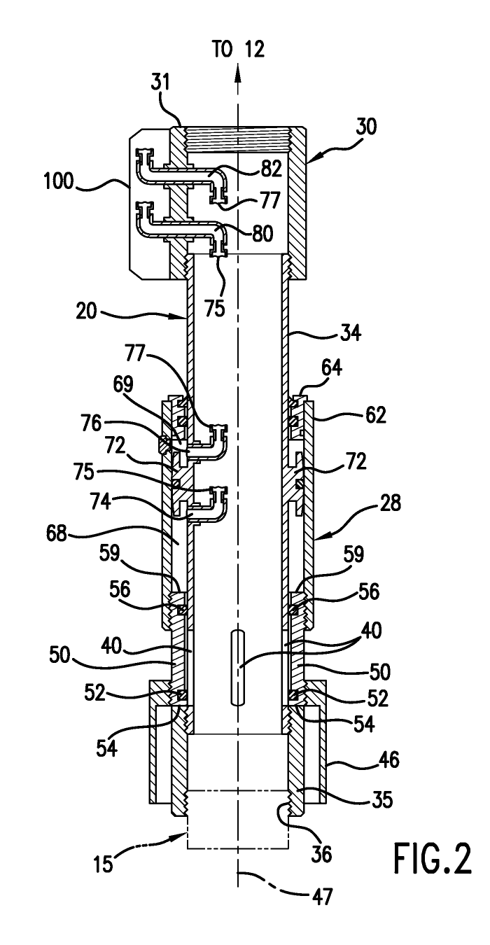

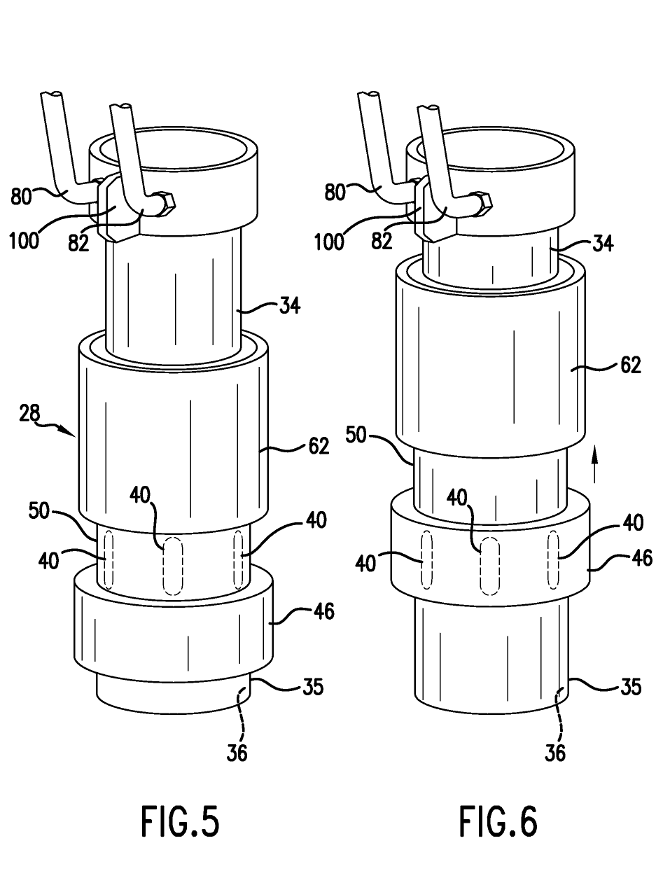

As is seen in FIGS. 2, 3 and 4, the downhole flow control 20 comprises a valve arrangement 28 is configured as a portion of a pipe section 30 for connecting the recharge pipe 12 with a source of the pressurized recharged water 13. The pipe section 30 includes an intermediate pipe portion 34, a lower portion 353 threaded to the intermediate pipe portion 34 and a lower end 36 that couples with the end device 15, which end device may be a return pump, an end flange or a flow inhibitor. The intermediate pipe portion 34 provides the location for operation of the valve 28 in that the intermediate pipe portion includes a plurality of outlet ports 40, which are preferably six in number, but may be any selected number which does not compromise the structural integrity of the middle portion of the pipe section 30. While for clarity, four outlet ports 30 are shown, it may be preferable to have eight slots, as is the case in the embodiment of FIGS. 5 and 6 employed to store treated waste water used for irrigation.

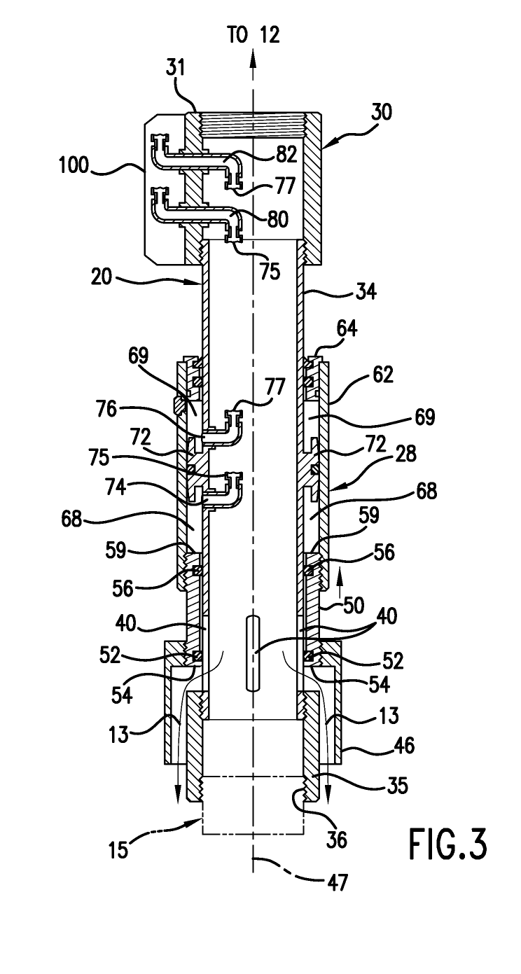

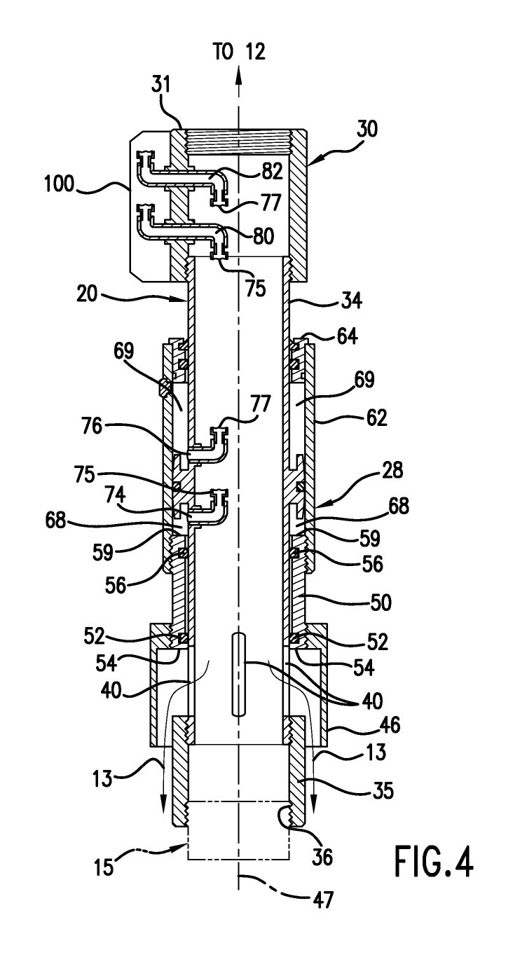

When the valve 28 is closed as in FIG. 2 no recharge water can flow through the outlet ports 40, but when the valve 28 is open as seen in FIGS. 3 and 4, recharge water 13 does flow through the outlet ports 40. According to the invention, a throttle skirt 46 deflects the recharge water 13 in a downward direction generally paralleling the longitudinal axis 47 of the pipe section 30. In this way, recharge water 13 is deflected downwardly so as not to not impinge on the walls 18 of the recharge well 10.

The throttle skirt 46 is fixed to a valve collar 50 which is slidably mounted around the intermediate sections 34 of the pipe section 30 for movement in the direction of the longitudinal axis 47 so as to cover and uncover the outlet ports 40, the outlet ports 40 being shown covered by the valve collar 50 in FIG. 2, partially covered in FIG. 3 and substantially completely open in FIG. 4. The valve collar 50 is sealed by seal 52, adjacent the lower end 54 thereof, and by seal 56 adjacent the upper end 59 thereof.

Threaded to the upper end 59 of the outlet cover 50 is an annular sleeve 62 that is sealed by a sealing collar 64 to define first and second chambers 68 and 69 therein which are separated by a partition 72 fixed therebetween to the intermediate portion 34 of the pipe section 30. Connected to the chamber 68 is a first port 74 connected to a first hydraulic line 75 and connected to the upper chamber 69 is a second hydraulic port 76 connected to a second hydraulic line 77. Hydraulic line 75 is connected to a hydraulic fitting 80 leading outside the pipe section 30, while the hydraulic line 77 is connected to a pipe fitting 82 also leading outside the pipe section 30. Hydraulic hoses (not shown) extend to the ground surface for pressurizing and relieving the chambers 68 and 69 that move the sealing collar 64.

In FIG. 2 the valve 28 is shown in its closed position wherein the valve sleeve 50 covers the outlet slots 40. In order to open the valve 28, the upper hydraulic chamber 69 is pressurized by fluid through the hydraulic inlet port 76, while the hydraulic port 74 allows hydraulic fluid to escape from the chamber 68. This causes the sleeve 62 to rise from the FIG. 2 position to the FIG. 3 position pulling the valve sleeve 50 upwardly so as to begin uncovering the outlet ports 40 so that recharge water 13 flows therethough into the recharge well 10 and aquifer 11.

The open area of the slot 40 can be increased to include the entire length of the outlet port 40 as is shown in FIG. 4 where the valve sleeve 50 is pulled to its top and fully open position. As is seen in FIG. 4, the throttle skirt 46 continues to keep the stream 41 directed downwardly toward the aquifer 11, rather than laterally against the side wall 8 of the recharge well 10.

The length of the outlets 40 can slowly be increased at the start of a recharge cycle to eliminate, or substantially eliminate, the rate of well recharge so as to avoid cascading of water 13 in the recharge pipe 12, which cascading traps air that can pass through the outlet ports 40 and be accumulated in the aquifer 11 so as to prevent further entry of recharge water. In a relatively short time such an accumulation of air can nullify an attempt to recharge an aquifer 11 with surface water 13. The valve sleeve 50 eliminates this problem.

FIG. 5 is a perspective view with the outlet openings 40 in dotted lines showing the valve 28 closed by the valve sleeve 50 while FIG. 6 is a perspective view showing the outlet openings 40 uncovered by the valve sleeve 50. In the embodiment of FIGS. 5 and 6 there are eight openings 40 in the intermediate sleeve 34 whereas in the embodiment of FIGS. 2-4 there are four outlet openings. To date, the downhole flow control has been made with internal diameters of about 4.5 inches and about 2.7 inches and external diameters of about 6.6 inches and about 4.5 inches, respectively. For protecting the hydraulic fittings 80 and 82 a radially and axially extending shield 100 is disposed adjacent to the hydraulic fittings. In the embodiment of FIGS. 5 and 6 the inlet fittings 80 and 82 are circumferentially spaced from one another, whereas in the embodiment of FIGS. 2-4 the inlet fittings 80 and 82 are spaced axially from one another in the direction of the longitudinal axis.

From the foregoing description, one skilled in the art can easily ascertain the essential characteristics of this invention, and without departing form the spirit and scope thereof, can make various changes and modifications of the invention to adapt it to various usages and conditions.

We claim:

1. A downhole flow control for use with a recharge well for recharging aquifers with a recharge pipe, the flow control comprising:
a valve configured as a pipe section having an upper end for connecting through the recharge pipe to a source of pressure water, an intermediate pipe section, and a lower end for coupling with a flow inhibitor;
a plurality of outlet ports in the intermediate section, through which outlet ports the pressurized water flows into the aquifer;
a sleeve over at least the intermediate pipe section, the sleeve being movable between a first position in which the sleeve covers the outlet ports to block the flow of water out of the outlet ports and a second position in which the sleeve at least partially uncovers the outlet ports to throttle water flow therefrom into the aquifer;
a throttle skirt extending axially from the sleeve and the throttle skirt having a length sufficient to overlie the outlet ports and being in radial spaced relation to the intermediate pipe section of the pipe section, a downwardly facing opening being defined by the throttle skirt to direct water passing through the openings into the well in the axial direction of the well for filing the aquifer, and
an actuator in operative relation with the sleeve to axially translate the sleeve so as to minimize cascading of refill water flowing down the recharge pipe.

2. The downhole flow control of claim 1 wherein the actuator is hydraulic.

3. The downhole flow control of claim 1 wherein the outlet ports are spaced elongated slots extending axially with respect to the pipe section.

4. The downhole flow control of claim 1 wherein the outlet ports are four to twelve in number.

5. The downhole flow control of claim 4 wherein the outlet ports are axially below the actuator so that the sliding sleeve progressively closes the outlets upon being lowered to cover the outlet ports.

6. The downhole flow control of claim 1 wherein the actuator is hydraulic comprising:
a double acting hydraulic actuator associated with the sleeve for moving the sleeve between the first and second positions to keep the recharge pipe filled with water, whereby air does not become entrained in the water as the water moves through the recharge pipe so as to enter the aquifer; the double acting hydraulic actuator comprising a first axially extending internal passage adjacent of the wall of the intermediate section and a second axially extending internal passage adjacent to the wall of the intermediate section, the first passage communicating with a first sub-chamber between the sleeve and the intermediate section and closed by the other side of the radially extending wall, whereby when the first sub-chamber is filled with hydraulic and the second sub-chamber is allowed to empty of fluid and the sleeve axially shifts to the first portion and when the second sub-chamber is allowed to empty of fluid the sleeve moves to the second position.

7. The downhole flow control of claim 1, wherein the valve is connected at the upper end thereof directly to the recharge pipe and connected at the lower end thereof to a vertical downhole pump, the vertical downhole pump having a foot valve at the other end thereof, the flow inhibitor being a check valve.

8. The downhole flow control of claim 1, wherein the valve configured as a pipe section is connected at the upper end thereof to the recharge pipe and wherein the flow inhibitor is a blind flange.
